(19) United States
(12) Patent Application Publication
(10) Pub. No.: US 2007/0251386 A1
(43) Pub. Date: Nov. 1, 2007

(54) DRY CYCLONE COLLECTION SYSTEM

(75) Inventors: FREEMAN J. SWANK, Olathe, KS (US); ANDREW E. PAGE, Kansas City, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: SCEPTOR INDUSTRIES INC., Kansas City, MO (US)

(21) Appl. No.: 11/739,964

(22) Filed: Apr. 25, 2007

Related U.S. Application Data
(60) Provisional application No. 60/795,542, filed on Apr. 27, 2006.

(51) Int. Cl. B01D 45/12; B01D 45/00

(52) U.S. Cl. 95/271; 96/413; 96/228

(57) ABSTRACT

A system and associated methods are disclosed for facilitating efficient collection of entrained material from an air/gas sample. In one arrangement, a method for collecting entrained material from a sample involves a dry collection cyclonic cycle combined with a period of fluid wash use. In particular, a sample is drawn into a chamber of a cyclone separator having a perimeter wall, and then a dry collection cyclonic separation cycle is performed on the sample for a period of time to separate a substantial amount of the entrained material from the sample. Subsequent to or temporally near an ending point of the dry collection cyclonic separation cycle, a fluid wash is injected into cyclone separator chamber so as to direct the fluid wash along the perimeter wall to capture material deposited on the walls and in the vortex break at the bottom of the cyclone separator.

### CROSS-REFERENCE TO RELATED APPLICATIONS

This application claims priority to commonly owned U.S. provisional application Ser. No. 60/795,542, filed Apr. 27, 2006, incorporated by reference in its entirety.

### STATEMENT REGARDING FEDERALLY SPONSORED RESEARCH OR DEVELOPMENT

Not applicable.

### BACKGROUND OF THE INVENTION

Cyclonic separation techniques are used to separate a mixture of relatively heavy particles from lighter particles, or to remove particulate matter or other entrained material from a fluid (e.g., wet collection) or gas/air stream (e.g., dry collection). Generally, cyclonic separation involves introducing a fluid or gas flow into a vertically oriented cylindrically-shaped chamber at such an orientation as to spin the flow along the vertical wall of the chamber, thereby utilizing centrifugal forces to force heavier material within the flow against the wall where such material falls under the influence of gravity to a lower collection point while the main flow continues in a downwardly spiraling motion. The cyclonic chamber typically tapers in diameter moving downwardly such that the cylindrical shape transitions into a frusto-conical shape. Once the inner diameter of the chamber is sufficiently reduced, a vortex break is produced which causes the fluid or gas flow (in some cases, with entrained “lighter” material) to change course and spiral upwardly through a centrally located vortex finder and out of the cyclonic chamber. It is also known that efficient separation in cyclonic separation is best achieved with a constant flow rate of the fluid or gas through the cyclonic chamber.

There is a desire to use cyclonic separation techniques to extract chemical or biological material, such as aerosols, from an air sample. As one example, there may be a need to sample the air within an enclosed area (e.g., a room of a building) to detect if harmful chemical or biological agents are present. In some cases however, the small size of the material within the air sample inhibits the effectiveness of dry collection cyclonic separation. Alternatively, if wet collection methods are implemented, the amount of liquid typically combined with the air sample is, relatively speaking, substantial, which may dilute or otherwise alter the material being collected or parameters surround the detection of the material in the collected sample. Thus, present cyclonic separation techniques and associated collection methods are frequently inadequate for collecting certain small micron-level material in such a way that the characteristics of the collected material in the original air/gas sample can be understood and studied.

### BRIEF SUMMARY OF INVENTION

A system and associated methods of the present invention provide efficient collection of entrained material from an air/gas sample. In particular, improved methods for performing cyclonic separation are disclosed where a fluid wash is utilized during a specific portion of a separation cycle for improved performance.

In one aspect, a method is provided for collecting entrained material from an air/gas sample where a dry collection cyclonic cycle is implemented. According to the method, a sample is first drawn into a chamber of a cyclone separator having a perimeter wall. A dry collection cyclonic separation cycle is performed on the sample within the chamber for a period of time to separate a substantial amount of the entrained material from the sample. Subsequent to an ending point of the dry collection cyclonic separation cycle, a fluid wash is injected cyclone separator chamber so as to direct the fluid wash along the perimeter wall of the chamber to capture material deposited on the walls and in the vortex break at the bottom of the cyclone separator. This provides the advantage that no fluid is used during the dry separation cycle until the end of the cycle where collected material may be suspended in a liquid.

Another aspect of the present invention is directed to an alternative method of collecting entrained material from an air/gas sample. In this method, a sample is first drawn into a chamber of a cyclone separator having a perimeter wall. A cyclonic separation cycle is performed on the sample within the chamber for a period of time to separate a substantial amount of the entrained material from the sample. The separation cycle is characterized by a ramp-up phase, a main separation phase, and a ramp-down phase. During the ramp-down phase of the separation cycle, a fluid wash is injected into the cyclone separation chamber so as to direct the fluid wash along the perimeter wall of the chamber to capture material deposited on the wall. This permits higher air sampling rates than traditional wetted cyclones, as there need not be a concern over loss of fluid caused by high air velocity during the collection cycle. Liquid based extraction may proceed at lower velocities while not performing sampling operations.

Additional advantages and features of the invention will be set forth in part in a description which follows, and in part will become apparent to those skilled in the art upon examination of the following, or may be learned by practice of the invention.

### BRIEF DESCRIPTION OF SEVERAL VIEWS OF THE DRAWINGS

The features of the invention noted above are explained in more detail with more reference to the embodiment illustrated in the attached drawing figures, in which like reference numerals denote like elements, in which the figures illustrate various embodiments of the present invention, and in which:

FIG. 1 is a fragmentary perspective view of a dry cyclone collection system in accordance with one embodiment of the present invention;

FIG. 2 is a sectional view of a cyclone separator chamber of the collection system depicting the movement of air/gas sample having entrained material;

FIG. 3 is a top view of a check valve of the dry cyclone collection system;

FIGS. 4A and 4B are perspective views of a self-sealing cyclone collection vessel, with FIG. 4A depicting the vessel with an inlet in the closed position and FIG. 4B depicting the vessel with the inlet in the open position;

FIG. 5 is a cross-sectional view taken along line 5-5 of FIG. 2; and

FIG. 6 is a cross-sectional view taken along line 6-6 of FIG. 2.

### DETAILED DESCRIPTION OF THE INVENTION

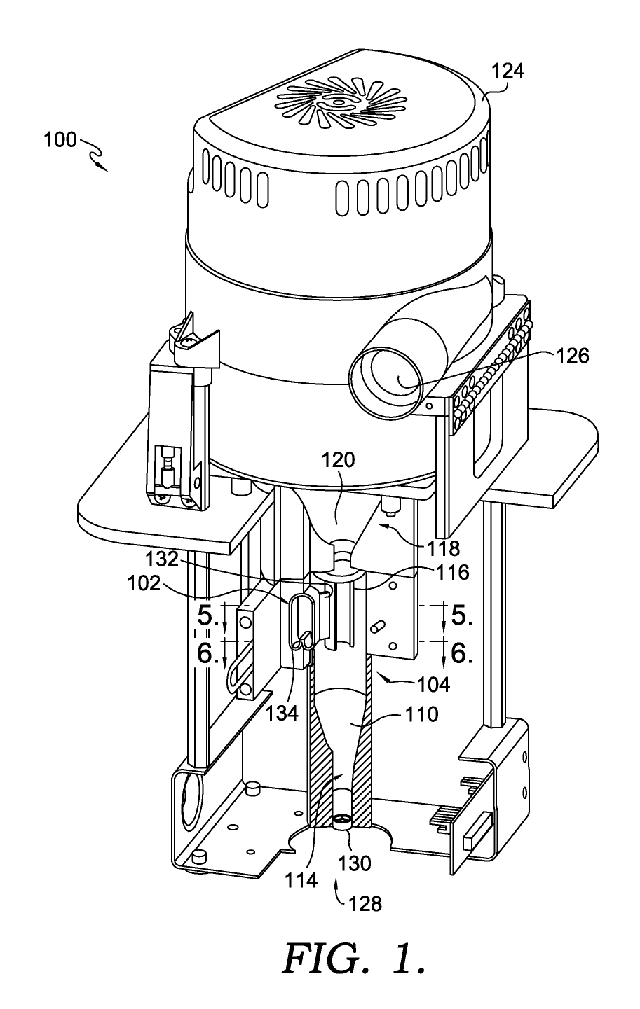

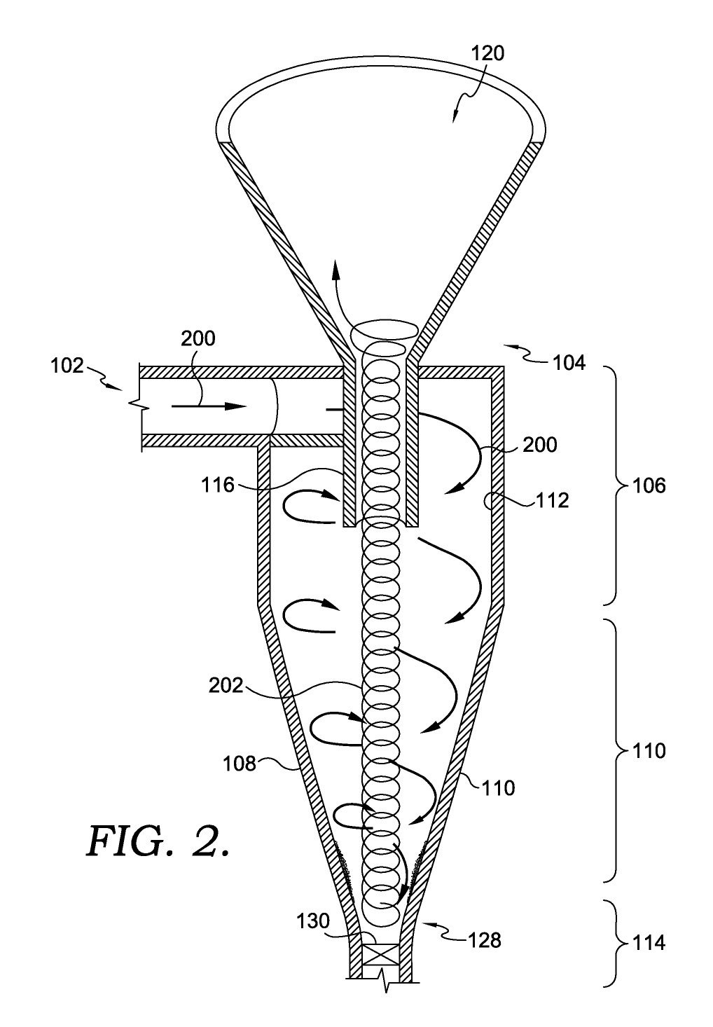

Turning now to the drawings, and initially to FIGS. 1 and 2, a cut-away perspective view of one embodiment of a dry cyclone collection system, or collector 100, is illustrated. An air/gas sample having micron-level material or particles (also referred to herein as “sampled material”) suspended or entrained therein is pulled into a tangential or scroll gas inlet 102, with an optional neutral vane 132. As one example, the suspended material may have a diameter of about 10 microns or less. Still, other material sizes may be collected by the collector 100 of the present invention. The gas inlet 102 is in communication with a main cyclonic chamber 104 of the collector 100. The main chamber 104 has a generally cylindrically shaped upper portion 106 and a frusto-conically shaped lower portion 108 that tapers in diameter moving downward to form a cyclone cup 110. The air sample now forms a main airflow 200 moving into the chamber upper portion 106 where the cylindrical geometry turns the flow along a wall 112 of the chamber 104. This turning motion generates centrifugal forces that cause the suspended material to impact the wall 112 and become adhered to the wall and slide or otherwise migrate downwardly along the wall under the force of gravity. The main airflow 200 continues in a downwardly turning or spiraling motion until the diameter of the cyclone cup 110 is sufficiently small as to form a lower vortex break 114. At this point, the main air flow 200 with substantially all of the suspended material above a minimum size removed therefrom, changes direction to form an upward air flow 202 moving in a spinning motion at a small turning radius. The upward air flow 202 moves within a central void of the main air flow 200 and is guided by a vortex finder 116 positioned generally at the central longitudinal axis of the chamber upper portion 106. Preferably, the vortex finder 116 is cylindrically shaped, with an inner diameter that is substantially smaller that the diameter of the chamber upper portion 106. As the upward air flow 202 moves through the vortex finder 116, the flow 202 encounters an upper vortex break 118 at a secondary chamber having a frusto-conically shaped transition cup 120. At this point, most of the remaining suspended material (or fluid wash, as will be more fully explained below) entrained in the upward air flow 202 would separate from the flow 202 and move to the surface wall of the vortex finder 116 or transition cup 120. The upward airflow 202 then continues on through a conventional air mover 124 and out of the collector 100 through a gas outlet 126. An extraction port 128, the opening of which may be controlled by a check valve 130, is formed at the base of the cyclone cup 110 to enable the removal of the sampled material that has settled to the bottom of the main chamber 104. This check valve 130 also serves to prevent clogging of the fluid outlet by collected material during the collection cycle. The surface of the chamber wall 112 may have a preselected degree of roughness to inhibit the clinging of the separated material to the wall 112 and thereby improve the migration of the material downwardly to the region of the extraction port 128.

As seen in FIG. 5, the neutral vane 132 aids in creating swirl in the air/gas sample moving through the inlet 102 into the main chamber 104. Below the neutral vane 132 in the main chamber 104, as shown in FIG. 6, the air/gas sample realizes the full cyclone effects as it moves downwardly from the chamber upper portion 106.

During the dry cyclone collection process, some deposited material usually clings to the wall 112 of the main cyclonic chamber 104 and fails to migrate to the area of the extraction port 128. In certain situations, this would not be a significant issue, such as when the objective is to merely detect the presence of a certain particulate matter or agent and the concentration of the material in the air sample is high enough that the dry cyclone collection process results in a sufficient deposit of the suspended matter at the extraction port 128 that can be analyzed. On the other hand, if there is a need to measure the concentration of the sampled material within the air sample, or if only a very small quantity of suspended material was present in the initial air sample, the conventional dry cyclone collection process will likely not produce the collection results desired.

Accordingly, in one embodiment of the present invention, the dry cyclone collection cycle is followed up by the injection of a small volume fluid wash in the vicinity of the gas inlet 102. The fluid wash preferably includes a surfactant to reduce the surface tension and improve washing of the chamber wall 112. Preferred volumes of injected fluid wash are between 2 and 25 milliliters for a collector 100 running up to about 400 liters per minute flow rate. The fluid wash is injected at an orientation (e.g., tangential to the chamber wall 112) so as to spiral down the chamber wall 112 and wash any deposited material clinging to the wall 112 down to the extraction port 128. As shown in particular in FIG. 1, the gas inlet 102 may be formed with a fluid control ridge or weir 134 at a lower region thereof and extending longitudinally through the inlet 102. The weir 134 controls how the fluid flow enters the chamber 104 so as to direct the fluid wash along the chamber wall 112 and away from the centrally located vortex finder 116 to prevent the liquid from being directly taken up in suction through an inlet of the vortex finder 116 in situations where the liquid wash is introduced during the ramp down phase of the cyclonic separation process, as will be more fully explained below.

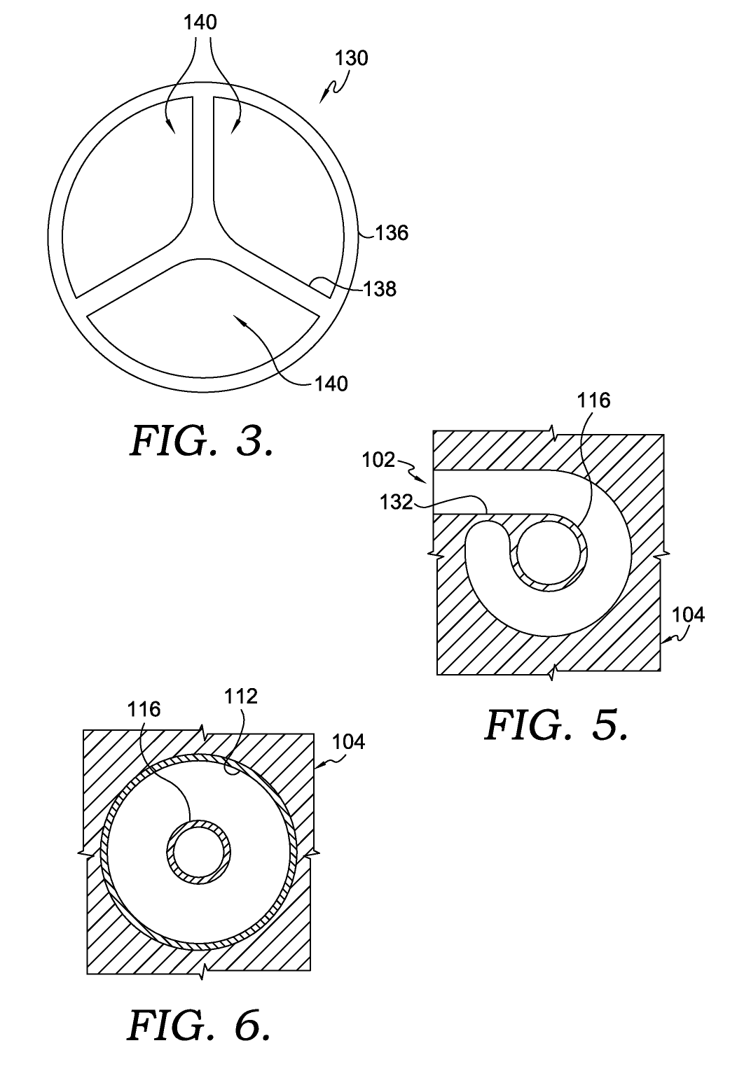

As mentioned above, the check valve 130 is positioned to control the opening and closing of the extraction port 128. The check valve 130 preferably has a flat profile so as to avoid extending upwardly into the volume of the chamber 104 or downwardly where particular material could build up and pack against the structure of the valve 130. Thus, the flat profile enables a more complete washing of the collected material. As seen in FIG. 3, one embodiment of the check valve 130 is formed by a perimeter wall 136 and inwardly extending flaps 140. This configuration presents a tri-slot design with the slots 138 extending from a center point generally at 120 degrees with respect to one another between the flaps 140. The tri-slot design allows for a sufficient material cross-sectional area for the flaps 140 so as to provide easy opening for low pressure drop fluid extraction when vacuum is placed on the downstream side by a positive displacement pump, but also provides reduced bow in the center of the valve 130 during the presence of vacuum on the upstream side while performing cyclonic separation that could potentially cause loss of collected material.

Preferably, in one method of collection, the check valve 130 keeps the extraction portion 128 closed during the dry cyclone collection process, and does not open the valve until a sufficient amount of the fluid wash has rinsed the chamber wall 112 and moved to the extraction port 128 where the deposited material becomes generally homogeneously distributed in the fluid wash. Thus, the fluid wash also serves to break up any clumps of material collected at the extraction port 128 which could clog the port 128, while providing a transporting medium for moving the fluid wash with suspended sampled material collected through the port and check valve 130 to a location for analysis. A vacuum draw may be coupled with a conduit connected to the check valve for removing the collected material through the extraction port 128 to a desired location. Because the volume of the fluid wash is relatively small, it does not substantially interfere with measuring the concentration of the sampled material or otherwise dilute the collected matter to the point where the matter cannot be detected or analyzed. It is possible to utilize such a small amount of fluid wash to capture remaining deposited material because of the relatively small size of the main cyclonic chamber 104 (i.e., a small form factor), which presents a small total surface area to be washed. Additionally, the collector 100 is preferably run at a higher flow rate that conventional dry cyclone collection processes would dictate, based on the particular size of the chamber 104 utilized in the present invention. The small form factor for the chamber 104 also increases the efficiency of collecting entrained matter that is 1 micrometer or less in size, which represents a significantly smaller size than is efficiently collected by most conventional cyclonic collection methods.

In another embodiment, the collection process involves injection of the fluid wash prior to the end of the cyclonic separation process, but as the air mover 124 is ramping down and the flow rate through the collector 110 is dropping from the steady state flow rate during the dry collection phase. Thus, some of the fluid wash may be entrained in the upward airflow 202 and move through the vortex finder 116 and into the transition cup 120. However, because the air mover 124 is in a ramp-down phase, which only continues for a few seconds, the fluid wash does not continue past the transition cup 120. Additionally, the broadening cross-sectional area of the transition cup 120 moving upwardly, and the overall height of the combined vortex finder 116 and transition cup 120, serve to inhibit the continued upward flow of the fluid wash. By having at least some of the fluid wash reach the region of the upper vortex break 118, a secondary wash of the surface of the vortex finder 116 and the transition cup 120 is provided in case any portion of the material to be collected was carried in the upward air flow 202 to this point. Upon stoppage of the air mover 124, the fluid wash entrained in the upward air flow 202 or otherwise deposited on the vortex finder 116 and transition cup 120 surfaces ends up falling by gravity back down the vortex finder 116 to the chamber lower portion 108 where it settles at the extraction port 128.

The particular design of the collector 100 is advantageous for engaging in cyclonic separation at relatively low ambient temperatures. Because of the small fluid wash volume utilized and the small overall side of the main cyclonic chamber 104, flexible heaters can quickly bring the temperature within the chamber 104 to a typical room temperature. Not only may heat be applied to the chamber wall 112 externally, but also the fluid wash, or air flow driving the extraction fluid around the walls of the cyclone cup, may be preheated before entering the collector 100.

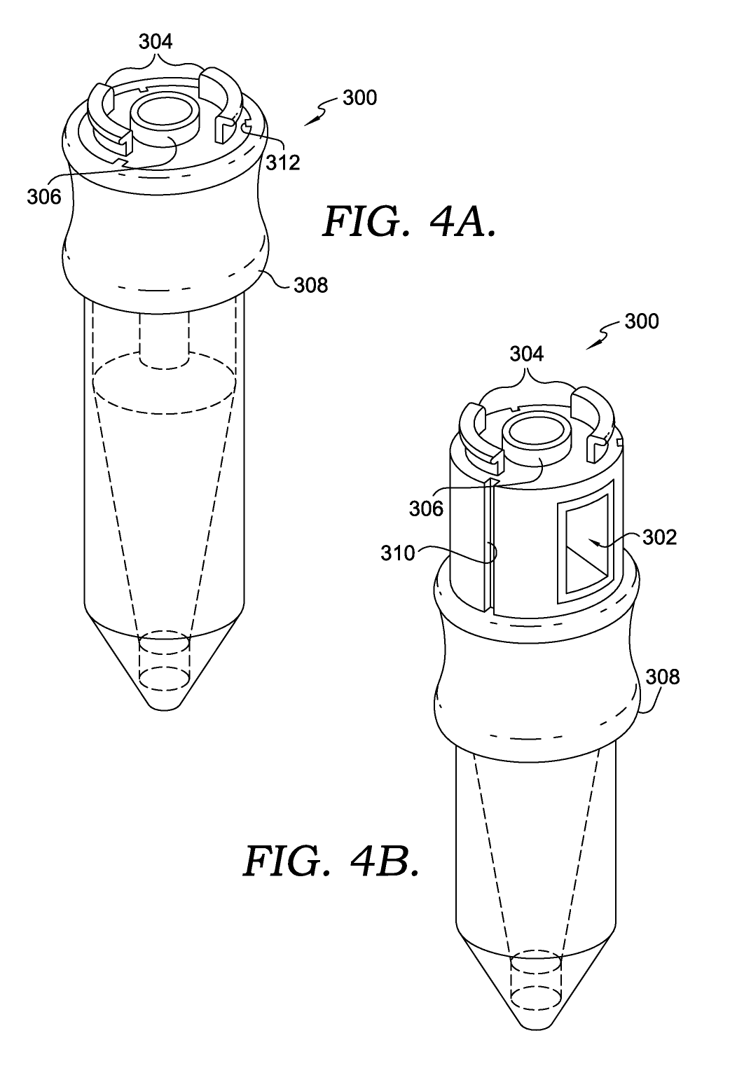

Turning to FIGS. 4A and 4B, a self-sealing cyclone collection vessel 300 is depicted. The vessel 300 serves the same function as the main cyclonic chamber 104 of FIGS. 1 and 2, but is removable so that the material collected may be analyzed at a remote location from the collector 100. The vessel 300 has an gas inlet 302 (analogous to gas inlet 102 of FIG. 1) seen in FIG. 4B, coupling flanges 304 for attachment with frame elements of the collector 100, an upper outlet 306 received within the lower end of the vortex finder 116 to enable the upward air flow 202 to escape the vessel 300, and a moveable sealing band 308 to close off the inlet 302 after the completion of a cyclonic separation cycle. The sealing band 308, for instance, may be biased to the closed position covering the inlet 302 when not attached to the remainder of the collector 100, as shown in FIG. 4A. The vessel 300 has a series of longitudinal channels 310 configured to receive therein a series of rails 312 formed on the sealing band 308 to facilitate the band 308 slidably moving relative to the vessel to alternately expose and cover the inlet 302.

As can be understood, the dry cyclone collector 100 and methods of operation of the present invention provide for increased collection efficiencies for micron-level material while maintaining high concentration factors necessary for sampling and analyzing certain materials, such as chemical or biological agents. Further, the collector 100 is relatively compact and easily portable to locations where it is desired to conduct material sampling.

Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A method of collecting entrained material from an air/gas sample, comprising:
drawing the sample into a chamber of a cyclone separator, the chamber having a perimeter wall;
performing a dry collection cyclonic separation cycle on the sample within the chamber for a period of time to separate a substantial amount of the entrained material from the sample, the cycle characterized by a starting point and an ending point; and
injecting, subsequent to the dry collection cyclonic separation cycle ending point, a fluid wash into the cyclone separator chamber so as to direct the fluid wash along the perimeter wall of the chamber to capture material deposited on the wall.

2. The method of claim 1, wherein at least some of the entrained material separated from the sample is less than 10 microns in diameter.

3. The method of claim 1, wherein the cyclone separator further includes a vortex finder within the chamber and a transition cup above the vortex finder, the transition cup being in fluid communication with the chamber through the vortex finder, and the step of performing a dry collection cyclonic separation cycle on the sample including separating at least some of the entrained material from the sample within at least one of the vortex finder and the transition cup.

4. The method of claim 1, wherein the cyclone separator further includes an extraction port at a bottom region of the chamber and a check valve disposed in the extraction port, the method further comprising:
maintaining the check valve in a closed position for at least some portion of the dry collection cyclonic separation cycle; and
maintaining the check valve in an open position for a period of time subsequent to injecting the fluid wash into the cyclone separator chamber.

5. A method of collecting entrained material from an air/gas sample, comprising:
drawing the sample into a chamber of a cyclone separator, the chamber having a perimeter wall;
performing a cyclonic separation cycle on the sample within the chamber for a period of time to separate a substantial amount of the entrained material from the sample, the cycle characterized by a ramp-up phase, a main separation phase, and a ramp-down phase; and
injecting a fluid wash into the cyclone separator chamber during the ramp-down phase so as to direct the fluid wash along the perimeter wall of the chamber to capture material deposited on the wall.

6. The method of claim 5, wherein the cyclone separator further includes a vortex finder within the chamber and a transition cup above the vortex finder, the transition cup being in fluid communication with the chamber through the vortex finder, and the step of performing a cyclonic separation cycle on the sample including:
separating at least some of the entrained material from the sample within at least one of the vortex finder and the transition cup; and
moving at least some of the fluid wash into the vortex finder and optionally into the transition cup to capture material deposited within at least one of the vortex finder and the transition cup.
